(19) United States
(12) Patent Application Publication
(10) Pub. No.: US 2019/0229412 A1
(43) Pub. Date: Jul. 25, 2019

(54) ANTENNA COVER AND CAR RADAR DEVICE

(71) Applicant: Wistron NeWeb Corp., Hsinchu (TW)

(72) Inventors: Shun-Chung KUO, Hsinchu (TW); Cheng-Geng JAN, Hsinchu (TW); Yi-Che TSAI, Hsinchu (TW)

(21) Appl. No.: 15/991,749

(22) Filed: May 29, 2018

(30) Foreign Application Priority Data
Jan. 19, 2018 (TW) 107102034

(51) Int. Cl. H01Q 1/42; H01Q 1/32; H01Q 1/38

(52) U.S. Cl. CPC H01Q 1/421; H01Q 1/38; H01Q 1/3275

(57) ABSTRACT

The invention provides an antenna cover for protecting an antenna element. The antenna cover includes a cover structure and a first non-smooth element. A hollow portion is formed in the cover structure. The first non-smooth element is distributed on a first inner edge of the cover structure. The first non-smooth element is configured to enhance the gain of the antenna element and increase the width of the main beam of the antenna element.

### CROSS REFERENCE TO RELATED APPLICATIONS

This Application claims priority of Taiwan Patent Application No. 107102034 filed on Jan. 19, 2018, the entirety of which is incorporated by reference herein.

### BACKGROUND OF THE INVENTION

### Field of the Invention

The disclosure generally relates to an antenna cover, and more particularly, it relates to an antenna cover for enhancing the gain of an antenna element and increasing the width of the main beam of the antenna element.

### Description of the Related Art

An antenna cover is an element configured to protect an antenna from being interfered with. However, a traditional antenna cover usually has a smooth shape, which tends to generate an undesirable second-order or higher-order diffusion and distort or destroy the radiation pattern of the antenna. Accordingly, there is a need to propose a novel solution for solving the problems of the prior art.

### BRIEF SUMMARY OF THE INVENTION

In an exemplary embodiment, the disclosure is directed to an antenna cover for protecting an antenna element. The antenna cover includes a cover structure and a first non-smooth element. A hollow portion is formed in the cover structure. The first non-smooth element is distributed on a first inner edge of the cover structure.

In another exemplary embodiment, the disclosure is directed to a car radar device. The car radar device includes an antenna cover and an antenna element. The antenna cover includes a cover structure and a first non-smooth element. A hollow portion is formed in the cover structure. The first non-smooth element is distributed on a first inner edge of the cover structure. The antenna element is covered by the antenna cover.

### BRIEF DESCRIPTION OF DRAWINGS

The invention can be more fully understood by reading the subsequent detailed description and examples with references made to the accompanying drawings, wherein:

FIG. 1A is a perspective view of an antenna cover according to an embodiment of the invention;

FIG. 1B is a back view of an antenna cover according to an embodiment of the invention;

FIG. 1C is a sectional view of an antenna cover according to an embodiment of the invention;

FIG. 1D is a top view of a triangular portion according to an embodiment of the invention;

FIG. 1E is a back view of an antenna cover according to an embodiment of the invention;

FIG. 1F is a back view of an antenna cover according to an embodiment of the invention;

FIG. 1G is a back view of an antenna cover according to an embodiment of the invention;

FIG. 1H is a back view of an antenna cover according to an embodiment of the invention;

FIG. 1I is a back view of an antenna cover according to an embodiment of the invention;

FIG. 2 is a diagram of the gain of an antenna element using an antenna cover according to an embodiment of the invention;

FIG. 3A is a back view of an antenna cover according to an embodiment of the invention;

FIG. 3B is a top view of a semicircular portion according to an embodiment of the invention;

FIG. 4A is a back view of an antenna cover according to an embodiment of the invention;

FIG. 4B is a top view of a rectangular portion according to an embodiment of the invention;

FIG. 5A is a perspective view of a car radar device according to an embodiment of the invention;

FIG. 5B is a back view of a car radar device according to an embodiment of the invention; and

FIG. 5C is a sectional view of a car radar device according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

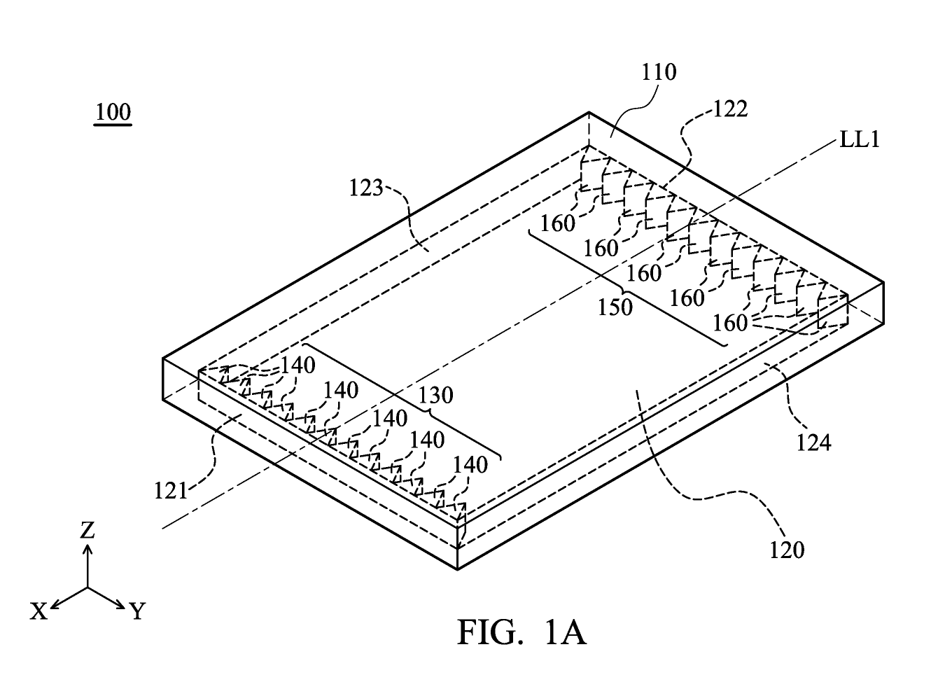

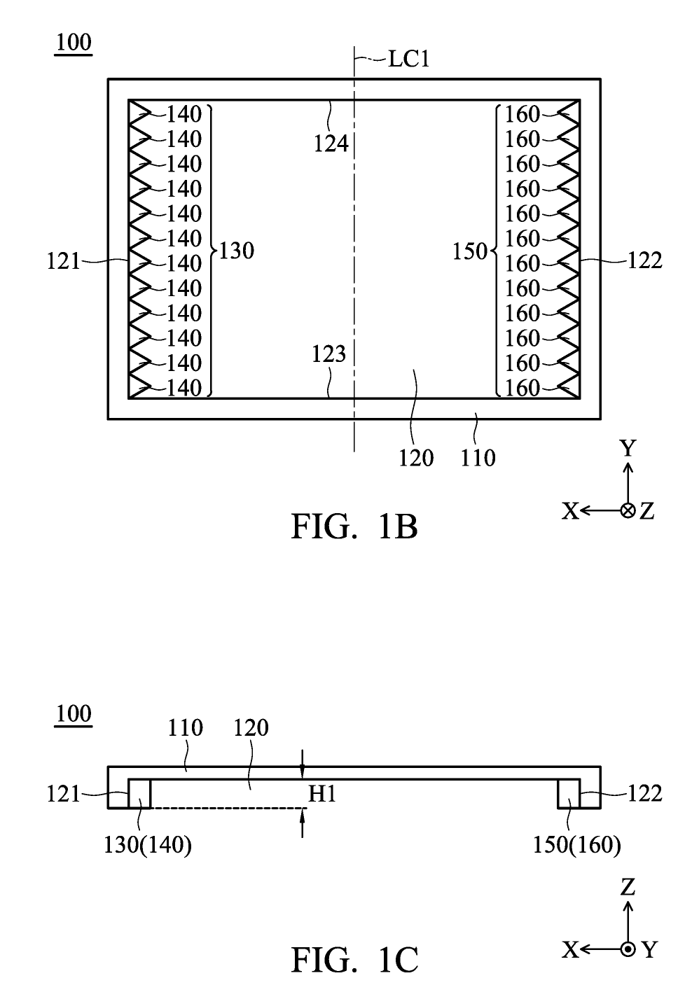

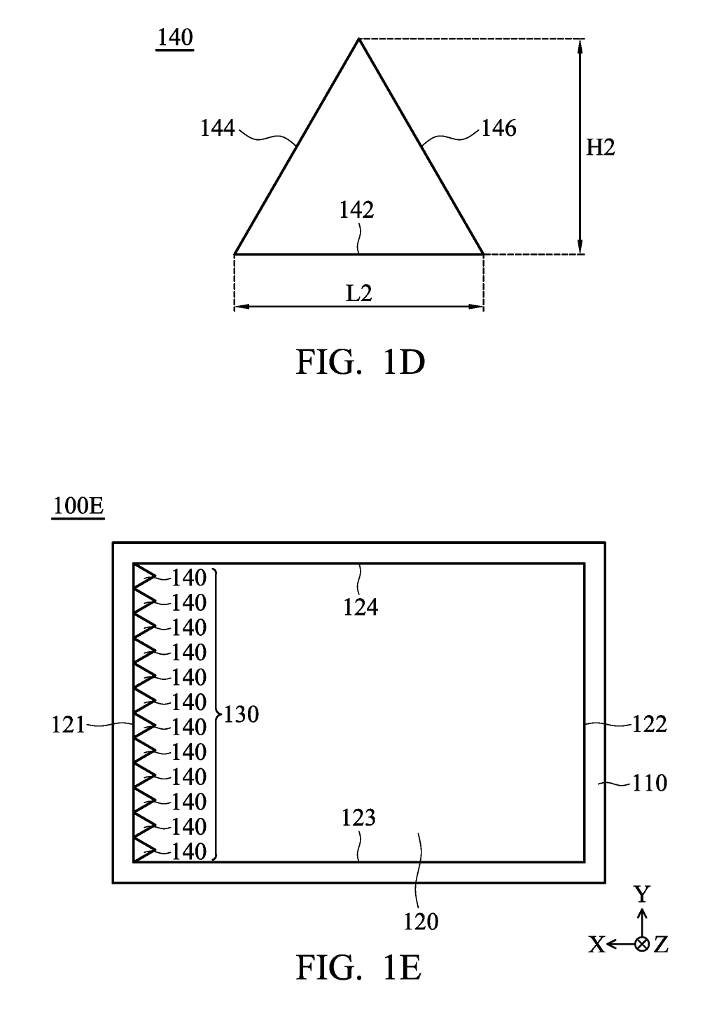

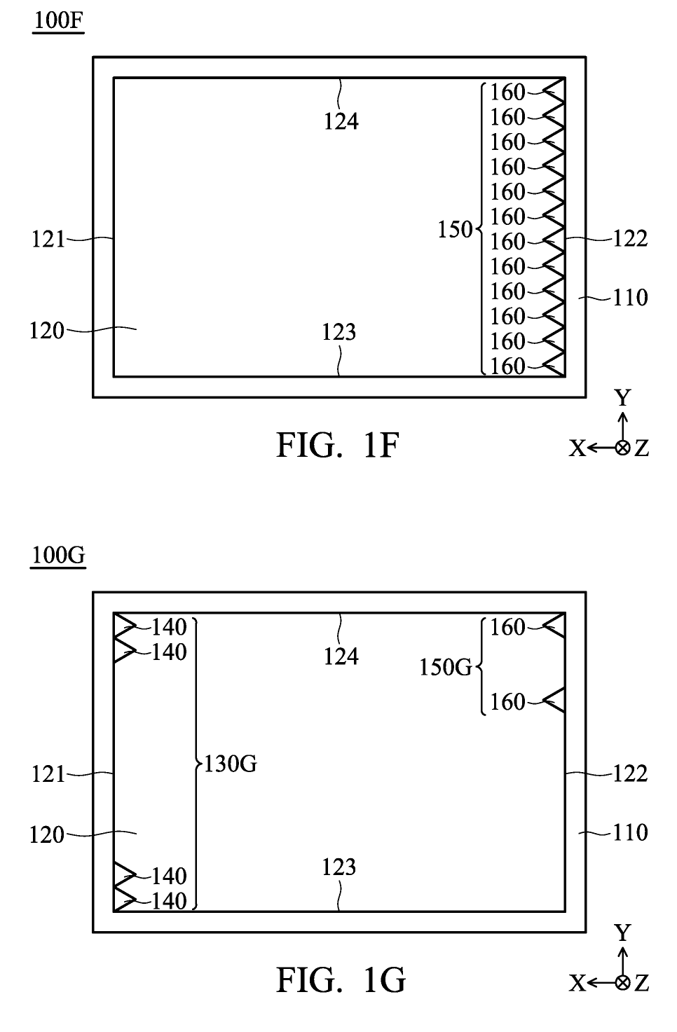

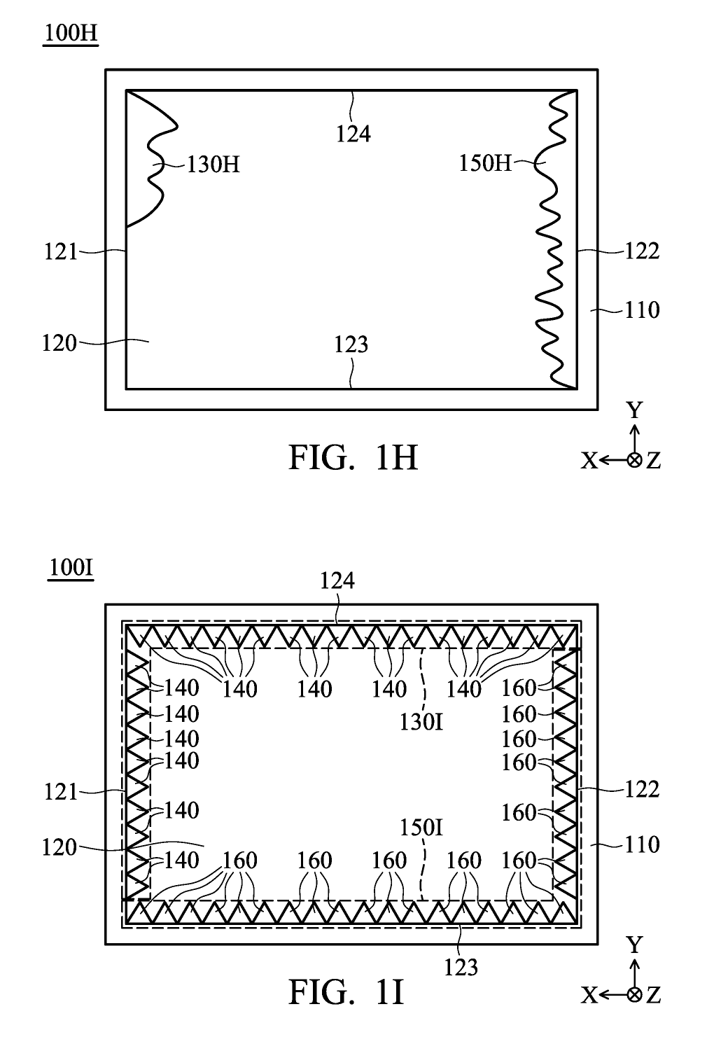

FIG. 1A is a perspective view of an antenna cover 100 according to an embodiment of the invention. FIG. 1B is a back view of the antenna cover 100 according to an embodiment of the invention. FIG. 1C is a sectional view of the antenna cover 100 according to an embodiment of the invention (along a sectional line LL1 of FIG. 1A). Please refer to FIG. 1A, FIG. 1B, and FIG. 1C together. In the embodiment of FIG. 1A, FIG. 1B, and FIG. 1C, the antenna cover 100 includes a cover structure 110, a first non-smooth element 130, and a second non-smooth element 150.

The cover structure 110 is made of any nonconductive material. In some embodiments, PBT (Polybutylene Terephthalate) accounts for 70% of the nonconductive material of the cover structure 110, and glass fiber accounts for 30% of the nonconductive material of the cover structure 110. Such a composition ratio can provide an appropriate dielectric constant and sufficient device robustness. A hollow portion 120 is formed in the cover structure 110, such that the cover structure 110 has a bottom opening for accommodating an antenna element. For example, the hollow portion 120 may substantially have a cuboid shape (hollow cuboid), but it is not limited thereto. Specifically, the cover structure 110 may have a first inner edge 121, a second inner edge 122, a third inner edge 123, and a fourth inner edge 124 due to the existence of the hollow portion 120. The second inner edge 122 is opposite and parallel to the first inner edge 121. The fourth inner edge 124 is opposite and parallel to the third inner edge 123. It should be noted that the first inner edge 121, the second inner edge 122, the third inner edge 123, and the fourth inner edge 124 of the cover structure 110 are equivalent to a first outer edge, a second outer edge, a third outer edge, and a fourth outer edge of the hollow portion 120, respectively. When the antenna cover 100 is used for protecting an antenna element (not shown), the antenna element may be disposed inside the hollow portion 120 of the cover structure 110, and the antenna element may be surrounded by the first inner edge 121, the second inner edge 122, the third inner edge 123, and the fourth inner edge 124 of the cover structure 110.

The first non-smooth element 130 is distributed on the first inner edge 121 of the cover structure 110. The second non-smooth element 150 is distributed on the second inner edge 122 of the cover structure 110. In some embodiments, the first non-smooth element 130, the second non-smooth element 150, and the cover structure 110 are integrally formed. The first non-smooth element 130, the second non-smooth element 150, and the cover structure 110 may be made of the same material. The first non-smooth element 130 and the second non-smooth element 150 are symmetrical with respect to their central line LC1. That is, the first non-smooth element 130 and the second non-smooth element 150 may have the same structure, and the only difference is that the first non-smooth element 130 and the second non-smooth element 150 are disposed in different directions. For example, each of the first non-smooth element 130 and the second non-smooth element 150 may substantially have a sawtooth shape, but it is not limited thereto. It should be noted that although the first non-smooth element 130 and the second non-smooth element 150 are both displayed in FIGS. 1A, 1B, and 1C, the antenna cover 100 may merely include either the first non-smooth element 130 or the second non-smooth element 150 in other embodiments (as shown in FIG. 1E and FIG. 1F).

Specifically, the first non-smooth element 130 may include a plurality of triangular portions 140 which are disposed adjacent to each other, and similarly, the second non-smooth element 150 may also include a plurality of triangular portions 160 which are disposed adjacent to each other. The term “adjacent” or “close” over the disclosure means that the distance (spacing) between two corresponding elements is shorter than a predetermined distance (e.g., 5 mm or the shorter), or that the two corresponding elements directly touch each other (i.e., the aforementioned distance/spacing therebetween is reduced to 0). FIG. 1D is a top view of the triangular portion 140 according to an embodiment of the invention. As shown in FIG. 1D, each of the triangular portions 140 may be substantially an isosceles triangle which has a bottom side 142 and two sides 144 and 146. The length of the side 144 may be the same as the length of the side 146. However, the invention is not limited to the above. In other embodiments, adjustments are made so that each of the triangular portions 140 is replaced with a different type of triangle, such as an equilateral triangle, a right triangle, or an isosceles right triangle. It should be understood that FIG. 1D can also describe each of the triangular portions 160 of the second non-smooth element 150.

Generally, the first non-smooth element 130 and the second non-smooth element 150 are configured to enhance the gain of the antenna element, and increase the width of the main beam of the antenna element. It should be understood that the hollow portion of the traditional antenna cover usually merely has smooth edges (e.g., the third inner edge 123 and the fourth inner edge 124 of the cover structure 110 may be classified as smooth edges), which tend to generate a second-order or higher-order diffusion of electromagnetic waves of the antenna element, and distort or destroy the radiation pattern of the antenna element. In order to solve this problem, the invention proposes to use at least one of the first non-smooth element 130 and the second non-smooth element 150. Such a design can prevent refraction or reflection of electromagnetic waves of the antenna elements from interfering with each other, so as to eliminate nulls in the radiation pattern of the antenna element.

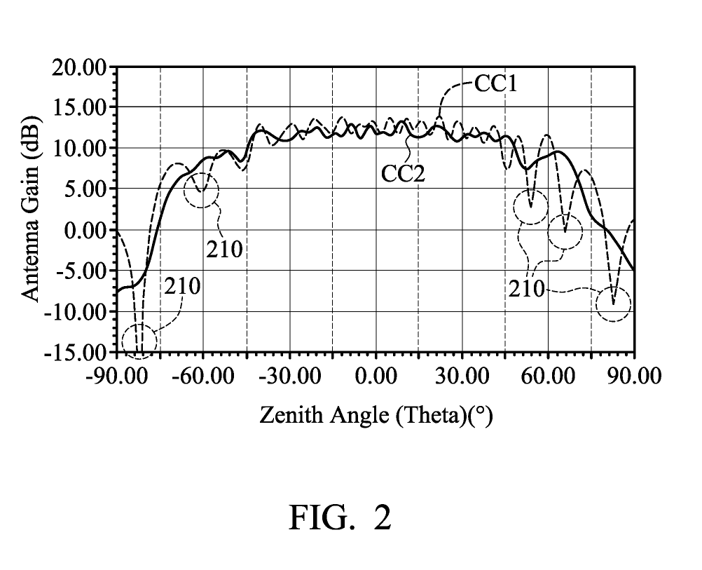

FIG. 2 is a diagram of the gain of the antenna element using the antenna cover 100 according to an embodiment of the invention (the gain may be measured on a plane parallel to the XZ plane, and the plane may pass through the antenna element). The horizontal axis represents the zenith angle (Theta) (degrees), and the vertical axis represents the gain (dB) of the antenna element. As shown in FIG. 2, a first curve CC1 represents the operation characteristic of the antenna element using a traditional antenna cover (whose cover structure has smooth inner edges), and a second curve CC2 represents the operation characteristic of the antenna element using the proposed antenna cover 100 (whose cover structure 110 is used together with at least one of the first non-smooth element 130 and the second non-smooth element 150). According to the comparison between the first curve CC1 and the second curve CC2, the radiation pattern of the antenna element using the traditional antenna cover generates a plurality of nulls 210 due to the diffusion effect, and the nulls 210 limit the gain and the main beam width of the antenna element; in comparison to the prior art, the proposed antenna cover 100 can effectively suppress the diffusion effect and eliminate the aforementioned nulls 210, so as to enhance the gain of the antenna element and increase the main beam width of the antenna element. Based on the measurement of FIG. 2, after the proposed antenna cover 100 is used, the gain of the antenna element at the nulls is improved by about 9 dB, and the 10 dB beam width of the antenna element is improved by about 17%.

In some embodiments, the antenna element for use in the antenna cover 100 has an operation frequency at around 24 GHz or 77 GHz. Therefore, the antenna element can support the frequency range of car radars. The aforementioned frequency range is adjustable according to different requirements.

Please refer to FIGS. 1A, 1B, 1C, and 1D together. In some embodiments, the element sizes of the antenna cover 100 are as follows. The height H1 of the hollow portion 120 of the cover structure 110 may be substantially equal to any positive integer multiple of 0.5 wavelength (λ/2) of the aforementioned operation frequency (i.e., H1=(λ/2)·N, where “N” is a positive integer, and “λ” is one wavelength of the aforementioned operation frequency). For example, the height H1 may be substantially equal to 0.5 wavelength (λ/2) of the aforementioned operation frequency. The length L2 of the bottom side 142 of each of the triangular portions 140 (or 160) may be longer than 0.5 wavelength (λ/2) of the aforementioned operation frequency. For example, the length L2 may be substantially equal to 1 wavelength (λ) of the aforementioned operation frequency. The height H2 of each of the triangular portions 140 (or 160) may be substantially equal to 0.5 wavelength (λ/2) of the aforementioned operation frequency. The above ranges of elements sizes are obtained and calculated according to many experiment results, and they help to maximize the performance of the antenna cover 100 used for eliminating the diffusion effect.

Although the first non-smooth element 130 and the second non-smooth element 150 are both periodic structures, the invention is not limited to the above. In alternative embodiments, the first non-smooth element 130 and the second non-smooth element 150 include non-periodic structures and/or irregular portions (as shown in FIGS. 1G and 1H), without affecting the performance of the invention. In addition, the first non-smooth element 130 and the second non-smooth element 150 are extendable and distributed on the third inner edge 123 and/or the fourth inner edge 124 of the cover structure 110 (as shown in FIG. 1I), thereby enhancing the performance of the invention.

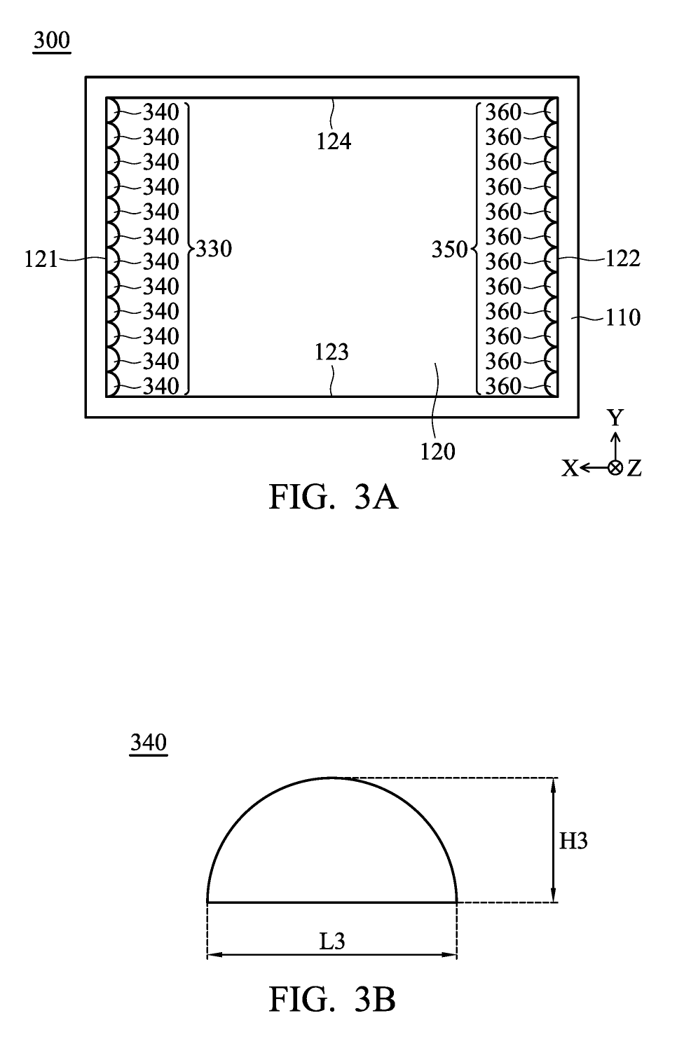

FIG. 3A is a back view of an antenna cover 300 according to an embodiment of the invention. FIG. 3A is similar to FIG. 1B. In the embodiments of FIG. 3A, the antenna cover 300 includes at least one of a first non-smooth element 330 and a second non-smooth element 350. The first non-smooth element 330 is distributed on the first inner edge 121 of the cover structure 110. The second non-smooth element 350 is distributed on the second inner edge 122 of the cover structure 110. Specifically, the first non-smooth element 330 may include a plurality of semicircular portions 340 which are disposed adjacent to each other, and similarly, the second non-smooth element 350 may also include a plurality of semicircular portions 360 which are disposed adjacent to each other. In other embodiments, adjustments are made so that each of the semicircular portions 340 and 360 is replaced with a semi-elliptical shape or an arc-shape. Other features of the antenna cover 300 of FIG. 3A are similar to those of the antenna cover 100 of FIGS. 1A, 1B, and 1C. Accordingly, the two embodiments can achieve similar levels of performance.

FIG. 3B is a top view of the semicircular portion 340 according to an embodiment of the invention. Similarly, the length L3 of the bottom side of each of the semicircular portions 340 (or the length of the diameter of the semicircular portion 340) may be longer than 0.5 wavelength (λ/2) of an operation frequency of an antenna element. For example, the length L3 may be substantially equal to 1 wavelength (λ) of the aforementioned operation frequency. The height H3 of each of the semicircular portions 340 (or the length of the radius of the semicircular portion 340) may be substantially equal to 0.5 wavelength (λ/2) of the aforementioned operation frequency. It should be understood that FIG. 3B can also describe each of the semicircular portions 360.

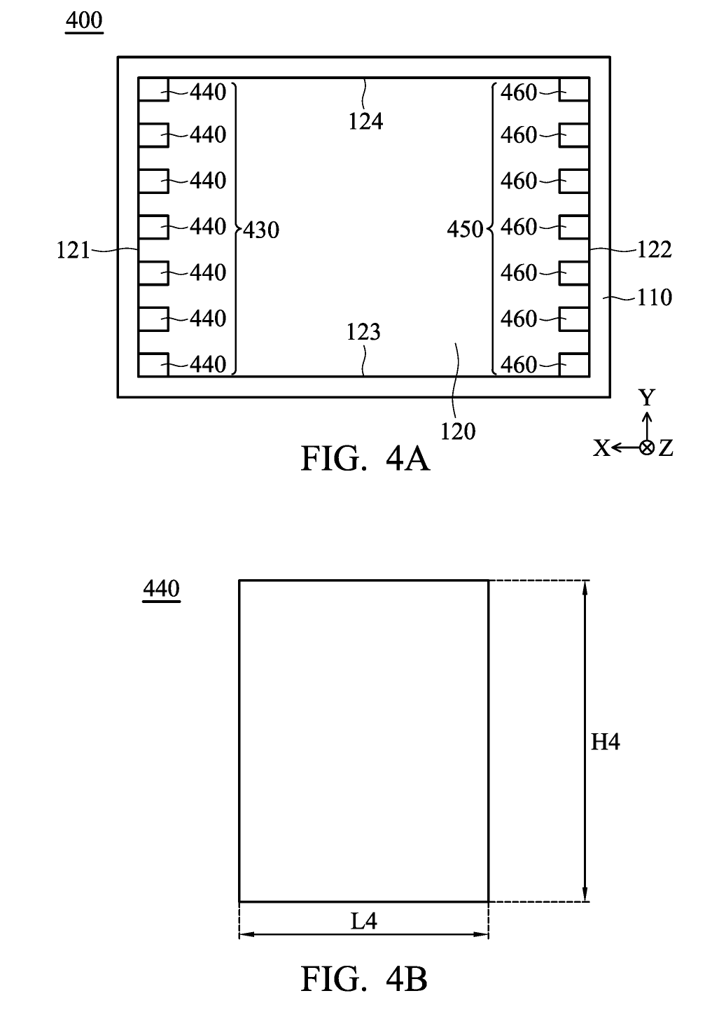

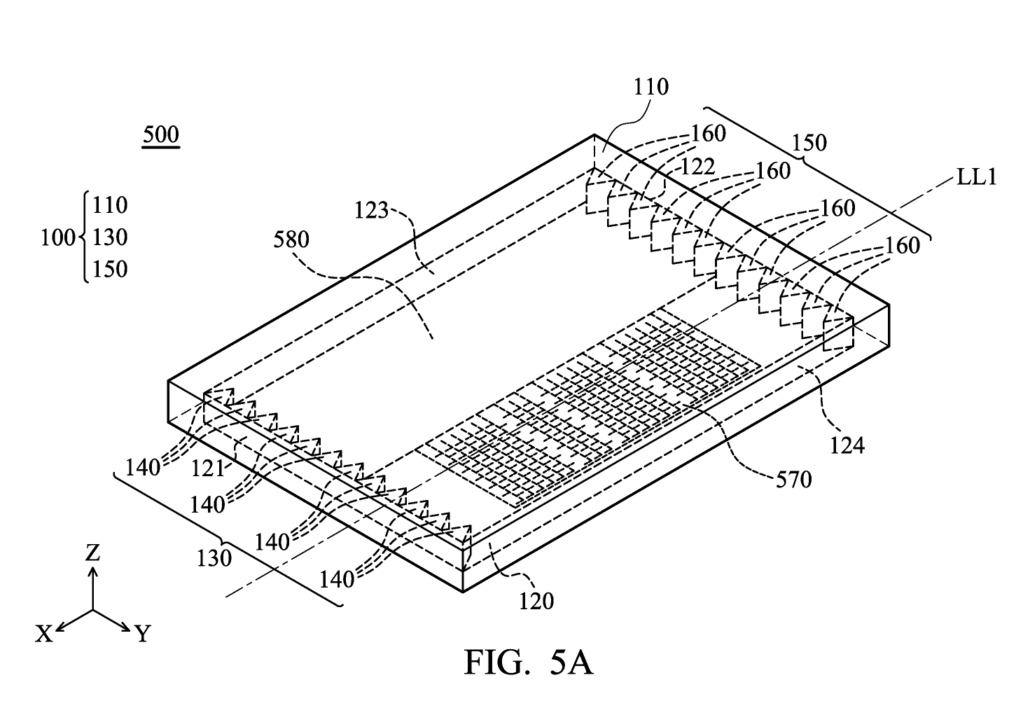

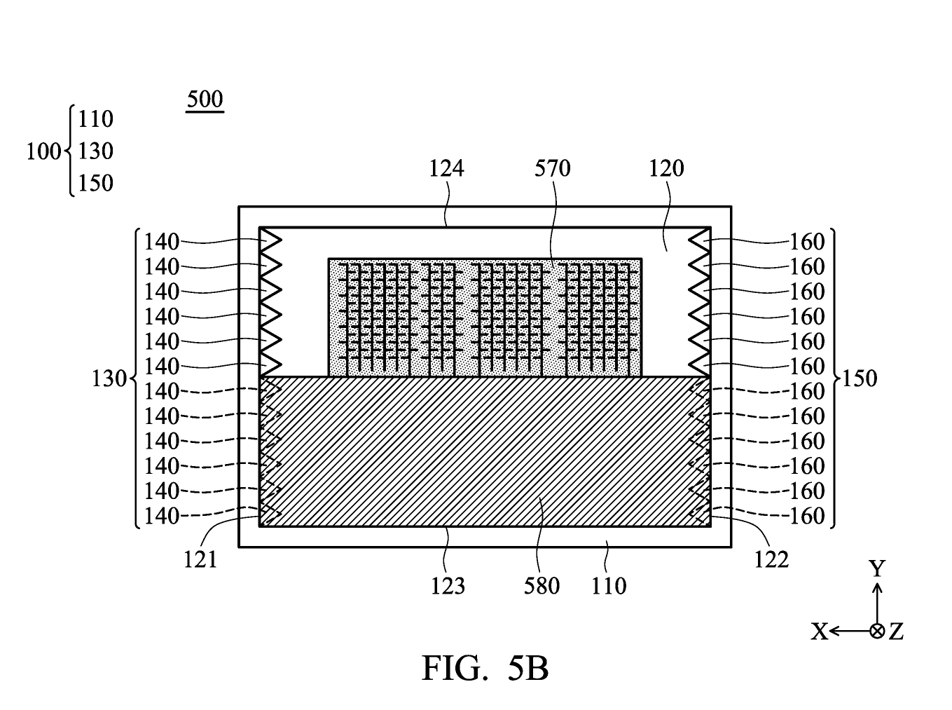

FIG. 4A is a back view of an antenna cover 400 according to an embodiment of the invention. FIG. 4A is similar to FIG. 1B. In the embodiments of FIG. 4A, the antenna cover 400 includes at least one of a first non-smooth element 430 and a second non-smooth element 450. The first non-smooth element 430 is distributed on the first inner edge 121 of the cover structure 110. The second non-smooth element 450 is distributed on the second inner edge 122 of the cover structure 110. Specifically, the first non-smooth element 430 may include a plurality of rectangular portions 440 which are separate from each other, and similarly, the second non-smooth element 450 may also include a plurality of rectangular portions 460 which are separate from each other. In other embodiments, adjustments are made so that each of the rectangular portions 440 and 460 is replaced with a square shape. Other features of the antenna cover 400 of FIG. 4A are similar to those of the antenna cover 100 of FIGS. 1A, 1B, and 1C. Accordingly, the two embodiments can achieve similar levels of performance.

FIG. 4B is a top view of the rectangular portion 440 according to an embodiment of the invention. Similarly, the length L4 of the bottom side of each of the rectangular portions 440 may be longer than 0.5 wavelength (λ/2) of the operation frequency of the antenna element. For example, the length L4 may be substantially equal to 1 wavelength (λ) of the aforementioned operation frequency. The height H4 of each of the rectangular portions 440 may be substantially equal to 0.5 wavelength (λ/2) of the aforementioned operation frequency. It should be understood that FIG. 4B can also describe each of the rectangular portions 460.

The above triangular portions, semicircular portions, and rectangular portions are considered as “composition portions” of the first non-smooth element or the second non-smooth element. The shapes of these “composition portions” are not limited in the invention.

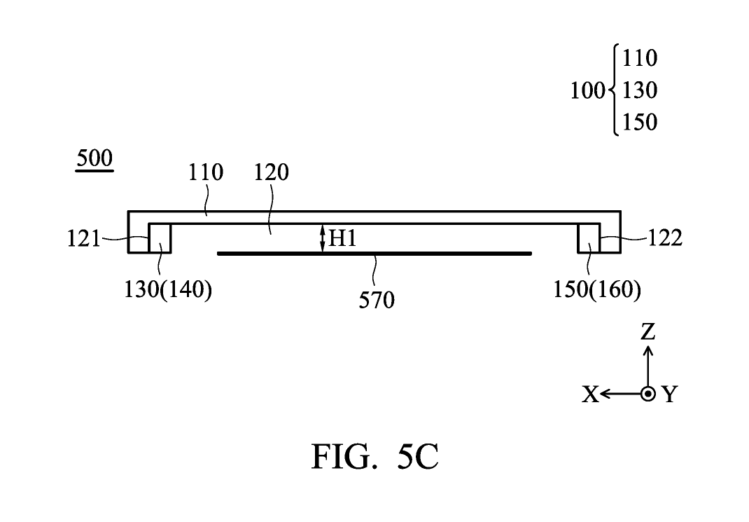

FIG. 5A is a perspective view of a car radar device 500 according to an embodiment of the invention. FIG. 5B is a back view of the car radar device 500 according to an embodiment of the invention. FIG. 5C is a sectional view of the car radar device 500 according to an embodiment of the invention (along a sectional line LL1 of FIG. 5A). The car radar device 500 is considered a practical application example of the antenna cover 100 of FIGS. 1A, 1B, and 1C. In the embodiment of FIG. 5A, FIG. 5B, and FIG. 5C, the car radar device 500 at least includes an antenna cover 100 and an antenna element 570. The antenna element 570 is covered by the antenna cover 100, and is disposed inside the hollow portion 120 of the cover structure 110. The car radar device 500 may further include other components, such as a processor, a PCB (Printed Circuit Board), and a plurality of metal traces, although they are not displayed in FIGS. 5A, 5B, and 5C. In some embodiments, the car radar device 500 further includes a ground plane 580. The ground plane 580 may substantially have a rectangular shape, and it may be disposed adjacent to the antenna element 570.

The antenna element 570 has an operation frequency at around 24 GHz or 77 GHz, so as to support the frequency range of car radars. The shape and type of the antenna element 570 are not limited in the invention. For example, the antenna element 570 may be a monopole antenna, a dipole antenna, a loop antenna, or a patch antenna. In alternative embodiments, the antenna element 570 is replaced with an antenna array. When the antenna element 570 is covered by the antenna cover 100, the height H1 of the hollow portion 120 of the cover structure 110 is equal to the shortest distance (spacing) between the cover structure 110 and the antenna element 570. In other words, the distance (spacing) between the antenna cover 100 and the antenna element 570 may be substantially equal to any positive integer multiple of 0.5 wavelength (λ/2) of the operation frequency of the antenna element 570. The structure, the characteristic, and the function of the antenna cover 100 have been described in detailed over the above embodiments, and they will not be illustrated again here. In addition, FIG. 2 may be considered as a practical measurement relative to the antenna element 570.

The invention proposes novel antenna covers for suppressing the diffusion effect of electromagnetic waves of antenna elements. In comparison to traditional antenna covers, the invention has at least the advantages of eliminating nulls in the antenna radiation patterns, enhancing the antenna gain, and increasing the width of the antenna's main beam. Therefore, the invention is suitable for application in a variety of radar devices, such as car radar devices.

Note that the above element sizes, element shapes, and frequency ranges are not limitations of the invention. An antenna designer can fine-tune these settings or values according to different requirements. It should be understood that the antenna cover and the car radar device of the invention are not limited to the configurations of FIGS. 1-5. The invention may merely include any one or more features of any one or more embodiments of FIGS. 1-5. In other words, not all of the features displayed in the figures should be implemented in the antenna cover and the car radar device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna cover for protecting an antenna element, comprising:
a cover structure, wherein a hollow portion is formed in the cover structure; and
a first non-smooth element, distributed on a first inner edge of the cover structure.

2. The antenna cover as claimed in claim 1, wherein the first non-smooth element is configured to enhance gain of the antenna element and increase a width of a main beam of the antenna element.

3. The antenna cover as claimed in claim 1, wherein the hollow portion substantially has a cuboid shape.

4. The antenna cover as claimed in claim 1, wherein the first non-smooth element substantially has a sawtooth shape.

5. The antenna cover as claimed in claim 1, wherein the antenna element has an operation frequency at around 24 GHz or 77 GHz.

6. The antenna cover as claimed in claim 5, wherein a height of the hollow portion is substantially equal to any positive integer multiple of 0.5 wavelength of the operation frequency.

7. The antenna cover as claimed in claim 5, wherein the first non-smooth element comprises a plurality of composition portions, and the composition portions are adjacent to each other.

8. The antenna cover as claimed in claim 7, wherein a length of a bottom side of each of the composition portions is longer than 0.5 wavelength of the operation frequency.

9. The antenna cover as claimed in claim 7, wherein a height of each of the composition portions is substantially equal to 0.5 wavelength of the operation frequency.

10. The antenna cover as claimed in claim 1, further comprising:
a second non-smooth element, distributed on a second inner edge of the cover structure, wherein the second inner edge is opposite to the first inner edge.

11. A car radar device, comprising:
an antenna cover, comprising:
a cover structure, wherein a hollow portion is formed in the cover structure; and
a first non-smooth element, distributed on a first inner edge of the cover structure; and
an antenna element, covered by the antenna cover.

12. The car radar device as claimed in claim 11, wherein the first non-smooth element is configured to enhance gain of the antenna element and increase a width of a main beam of the antenna element.

13. The car radar device as claimed in claim 11, wherein the hollow portion substantially has a cuboid shape.

14. The car radar device as claimed in claim 11, wherein the first non-smooth element substantially has a sawtooth shape.

15. The car radar device as claimed in claim 11, wherein the antenna element has an operation frequency at around 24 GHz or 77 GHz.

16. The car radar device as claimed in claim 15, wherein a height of the hollow portion is substantially equal to any positive integer multiple of 0.5 wavelength of the operation frequency.

17. The car radar device as claimed in claim 15, wherein the first non-smooth element comprises a plurality of composition portions, and the composition portions are adjacent to each other.

18. The car radar device as claimed in claim 17, wherein a length of a bottom side of each of the composition portions is longer than 0.5 wavelength of the operation frequency.

19. The car radar device as claimed in claim 17, wherein a height of each of the composition portions is substantially equal to 0.5 wavelength of the operation frequency.

20. The car radar device as claimed in claim 11, wherein the antenna cover further comprises:
a second non-smooth element, distributed on a second inner edge of the cover structure, wherein the second inner edge is opposite to the first inner edge.
